(19) United States
(12) Patent Application Publication
(10) Pub. No.: US 2013/0254102 A1
(43) Pub. Date: Sep. 26, 2013

(54) Systems and Methods for Distributing Tokenization and De-Tokenization Services

(71) Applicant: FIRST DATA CORPORATION, Greenwood Village, CO (US)

(72) Inventor: Vijay Kumar Royyuru, Norristown, PA (US)

(73) Assignee: FIRST DATA CORPORATION, Greenwood Village, CO (US)

(21) Appl. No.: 13/790,871

(22) Filed: Mar. 8, 2013

Related U.S. Application Data
(60) Provisional application No. 61/613,240, filed on Mar. 20, 2012.

(51) Int. Cl. G06Q 20/38

(52) U.S. Cl. CPC G06Q 20/382
USPC 705/39

(57) ABSTRACT

This disclosure describes systems and methods related to distributing tokenization and de-tokenization services. Information associated with a proposed payment transaction may be received by a payment transaction service provider system. The information may comprise a token generated by a tokenization service provider. A de-tokenization service provider separate from the tokenization service provider may be identified based at least in part upon the received information. The token may be routed by a payment transaction service provider system to the de-tokenization service provider for processing.

### RELATED APPLICATIONS

This application claims priority to U.S. Provisional Patent Application No. 61/613,240, entitled “Systems and Methods for Distributing Tokenization and De-tokenization Services,” filed on Mar. 20, 2012, the contents of which are incorporated by reference herein in their entirety.

### TECHNICAL FIELD

Embodiments of the disclosure relate generally to payment transactions, and more specifically to the distribution of tokenization and de-tokenization services in conjunction with payment transactions.

### BACKGROUND

A wide variety of payment devices are utilized by consumers in association with payment transactions. Increasingly, mobile devices and other contactless payment devices are being employed in conjunction with payment transactions. Typically, a contactless payment device includes near field communication (“NFC”) functionality (or other contactless functionality) that facilitates the communication of data from the payment device to a recipient NFC reader device. However, in certain situations, such as situations in which a mobile device does not include a secure element, information stored on a payment device and communicated from the payment device to a merchant point of sale (“POS”) device is vulnerable to security attacks. Accordingly, it may not be safe to store static payment credentials on unsecured payment devices.

One solution that has been employed to provide security for contactless transactions is the use of tokens in place of payment credentials. A payment device typically accesses a tokenization service in order to obtain a one-time token for use in a payment transaction. The token is then provided to a merchant POS device and, during the completion of the payment transaction, the token is returned to the tokenization service in order to obtain the payment credentials for the consumer. However, as the number of transactions increases, a tokenization service may become overloaded with tokenization and de-tokenization requests, thereby becoming a bottleneck in transaction processing that increases transaction delays. Accordingly, there is an opportunity for improved systems and methods for distributing tokenization and de-tokenization services.

### BRIEF DESCRIPTION OF THE DISCLOSURE

Certain embodiments of the disclosure can address some or all of the above needs. Certain embodiments of the disclosure can provide systems and methods for the distribution of tokenization and de-tokenization services in conjunction with payment transactions. In one embodiment, a computer-implemented method may include a payment transaction service provider system receiving information associated with a proposed payment transaction. The information may comprise at least a token generated by a tokenization service provider. The computer-implemented method may further include identifying a de-tokenization service provider separate from the tokenization service provider based at least in part upon the received information. The computer-implemented method may further include routing, to the de-tokenization service provider, at least the token for processing.

In one aspect of an embodiment, receiving information associated with a proposed payment transaction may include receiving information from one of (i) a merchant device, (ii) a consumer device, or (iii) a merchant acquiring system.

In one aspect of an embodiment, the token may be associated with at least one of (i) a payment credential, (ii) payment account information, or (iii) information associated with at least one value added service.

In one aspect of an embodiment, identifying a de-tokenization service provider may further include identifying a banking identification number included in the token. The embodiment may further include determining the de-tokenization service provider based at least in part upon the banking identification number. In another aspect of the embodiment, the banking identification number may be associated with a plurality of de-tokenization service providers. The embodiment may include selecting one of the plurality of de-tokenization service providers based at least in part on one or more criteria.

In one embodiment, one or more computer-readable media may be provided. The one or more computer-readable media may be configured to store computer-executable instructions. When executed by one or more processors, the computer-executable instructions may configure the one or more processors to receive information associated with a proposed payment transaction. The information may include at least a token generated by a tokenization service provider. Additionally, the computer-executable instructions may configure the one or more processors to identify a de-tokenization service provider separate from the tokenization service provider based at least in part upon the received information. Further, the computer-executable instructions may configure the one or more processors to route to the de-tokenization service provider at least the token for processing.

In one aspect of an embodiment, the computer-executable instructions may configure the one or more processors to receive information associated with a proposed payment transaction where the information may be received from one of (i) a merchant device, (ii) a consumer device, or (iii) a merchant acquiring system.

In one aspect of an embodiment, the token may be associated with at least one of (i) a payment credential, (ii) payment account information, or (iii) information associated with at least one value added service.

In one aspect of an embodiment, the computer-executable instructions may configure the one or more processors to identify a de-tokenization service provider. Identifying the de-tokenization service provider may include identifying a banking identification number included in the token. Further, the de-tokenization service provider may be determined based at least in part upon the banking identification number.

In one aspect of an embodiment, the banking identification number may be associated with a plurality of de-tokenization service providers. Further, the computer-executable instructions may configure the one or more processors to select one of the plurality of de-tokenization service providers based at least in part on one or more criteria.

In another embodiment, a computer-implemented method may include receiving, from a requesting device by a tokenization service provider system, a request to generate a token for use in a payment transaction. The computer-implemented method may further include generating, in response to the received request, the token. The token may include information that facilitates an identification of a de-tokenization service provider system separate from the tokenization service provider system. The computer-implemented method may further include communicating the generated token to the requesting device.

In one aspect of an embodiment, the token may be associated with at least one of (i) a payment credential, (ii) payment account information, or (iii) information associated with at least one value added service.

In one aspect of an embodiment, receiving a request may include receiving a request from one of (i) a consumer device or (ii) a merchant device.

In one aspect of an embodiment, the information that facilitates an identification of a de-tokenization service provider may include a banking identification number.

In one aspect of an embodiment, the banking identification number may be associated with a plurality of de-tokenization service providers. The computer-implemented method may further include selecting one of the plurality of de-tokenization service providers based at least in part on one or more criteria.

In one embodiment, one or more computer-readable media may be provided. The one or more computer-readable media may be configured to store computer-executable instructions. When executed by one or more processors, the computer-executable instructions may configure the one or more processors to receiving, from a requesting device, a request to generate a token for use in a payment transaction. The computer-executable instructions may configure the one or more processors to generate the token in response to the received request. The token may include information that facilitates an identification of a de-tokenization service provider system separate from the tokenization service provider system. Further, the computer-executable instructions may configure the one or more processors to communicate the generated token to the requesting device.

In one aspect of an embodiment, the token may be associated with at least one of (i) a payment credential, (ii) payment account information, or (iii) information associated with at least one value added service.

In one aspect of an embodiment, the computer-executable instructions may configure the one or more processors to receive a request, where the request may be received from one of (i) a consumer device or (ii) a merchant device.

In one aspect of an embodiment, the information that facilitates an identification of a de-tokenization service provider may include a banking identification number.

In one aspect of an embodiment, the banking identification number may be associated with a plurality of de-tokenization service providers. Further, the computer-executable instructions may configure the one or more processors to a select one of the plurality of de-tokenization service providers based at least in part on one or more criteria.

Additional systems, methods, apparatus, features, and aspects are realized through the techniques of various embodiments of the disclosure. Other embodiments and aspects of the disclosure are described in detail herein and are considered a part of the claimed disclosure. Other features and aspects can be understood with reference to the description and to the drawings.

### BRIEF DESCRIPTION OF THE FIGURES

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 illustrates a block diagram of an example system that may be utilized in accordance with various embodiments of the disclosure to facilitate the distribution of tokenization and de-tokenization services.

FIGS. 2 and 3 illustrate flow diagrams of example processes for completing a payment transaction utilizing transaction-related information communicated from a payment device to a recipient device, in accordance with illustrative embodiments of the disclosure.

FIGS. 4 and 5 illustrate flow diagrams of example processes for tokenizing and de-tokenizing payment credentials, in accordance with illustrative embodiments of the disclosure.

### DETAILED DESCRIPTION

Various embodiments of the disclosure are directed to systems and methods for facilitating the completion of payment transactions in which tokenization and de-tokenization services may be distributed. In one example embodiment, a card issuer or financial institution may provide payment credential data (e.g., account data, etc.) and information associated with the generation of tokens (e.g., key information, certificate information, encryption information, information associated with the generation of unique transaction values, etc.) to one or more tokenization services or tokenization service providers. Additionally, the card issuer or financial institution may provide payment credential data and token generation data to one or more de-tokenization services or de-tokenization service providers. In this regard, the tokenization services and the de-tokenization services may independently determine a wide variety of token information, such as information utilized to generate tokens and/or information utilized to de-tokenize or decrypt tokens. As a result, tokenization and de-tokenization services may be distributed among a plurality of entities.

During a payment transaction, a payment device (or another device associated with a payment transaction) or a consumer device may request a token from a tokenization service provider. The tokenization service provider may utilized stored payment credential data and/or various token data, such as stored keys, certificates, and/or various unpredictable, nonce, or varying data to generate or create a token for the payment transaction. A wide variety of suitable methods and/or techniques may be utilized to generate a token, such as key-based encryption, the identification of a reference value that identifies stored payment credentials, etc. Additionally, in certain embodiments, a token may be a unique token for one time use in association with a payment transaction. As desired, a token may also have a relatively limited lifespan and/or be associated with a wide variety of other security techniques (e.g., hashing, use of a checksum, etc.).

In certain embodiments, a generated token may include information that specifies or identifies a de-tokenization service provider to which the token should be routed for de-tokenization. According to an aspect of the disclosure, the de-tokenization service provider may be separate from the tokenization service provider. Additionally, a wide variety of different types of information may be utilized to identify a de-tokenization service. For example, the generated token may include a Banking Identification Number (“BIN”) that identifies a de-tokenization service provider or that may be utilized to identify a de-tokenization service provider. As another example, the generated token may include a header, portion of a header, or other identifier that may be evaluated in order to determine a de-tokenization service provider.

Once a token has been generated by a tokenization service, the token may be returned to the payment device in response to the token request. The payment device may then communicate or provide the token to a recipient device (e.g., a merchant point of sale (“POS”) device, another mobile device, etc.) in association with the payment transaction. For example, the token may be provided during a suitable NFC communication (e.g., a card emulation communication, a reader/writer communication, a peer to peer communication, etc.) or any other suitable communication (e.g., a Bluetooth communication, a radio frequency (“RF”) communication, a Wi-Fi communication, etc.). The recipient device may receive the token and utilize the received token in conjunction with the completion of the payment transaction. In certain embodiments, the recipient device may communicate a transaction approval request, the received token, and/or other transaction-related requests (e.g., requests for various value added services (“VAS”)) to a card issuer and/or any number of service providers. A card issuer or a service provider may communicate or provide the token to a de-tokenization service provider in order to obtain a payment credential for the transaction. In other embodiments, the recipient device may communicate the token to a de-tokenization service provider in association with the transaction.

As desired in various embodiments, a de-tokenization service provider may be identified for delivery or routing of the token. For example, a de-tokenization service provider may be identified by a merchant, a merchant acquirer, or a service provider. A wide variety of suitable methods or techniques may be utilized to identify the de-tokenization service provider. For example, in certain embodiments, a BIN or header included in the token may be evaluated in order to identify the de-tokenization service provider. In other embodiments, payment account issuer (e.g., card issuer, etc.) preferences (e.g., preferences associated with preferred de-tokenization services, load balancing preferences, preferences that are utilized to evaluate transaction-related information, etc.) may be evaluated in order to identify the de-tokenization service provider. In yet other embodiments, other transaction-related information may be utilized in order to identify the de-tokenization service provider. Additionally, in certain embodiments, a BIN or other identifier may be associated with a plurality of de-tokenization service providers (e.g., a plurality of de-tokenization servers, etc.), and one of the plurality of de-tokenization service providers may be selected based upon one or more other criteria (e.g., a routing component may iterate or rotate between various de-tokenization service providers to facilitate load balancing, loads for each of the de-tokenization service providers may be evaluated, etc.) may be evaluated in order to select a de-tokenization service provider.

Once identified and/or selected, a de-tokenization service provider may receive a token associated with a payment transaction. The de-tokenization service provider may then utilize key information, certificates, and/or various decryption algorithms and/or techniques in order to determine payment credential information (e.g., an account number, etc.) associated with the payment transaction. In certain embodiments, the de-tokenization service provider may utilize information received from a card issuer in order to de-tokenize a token. Determined payment credential information may then be provided to an entity that requested de-tokenization and/or to a card issuer to facilitate approval of and/or settlement of the payment transaction.

Embodiments of the disclosure now will be described more fully hereinafter with reference to the accompanying drawings, in which certain embodiments are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

### System Overview

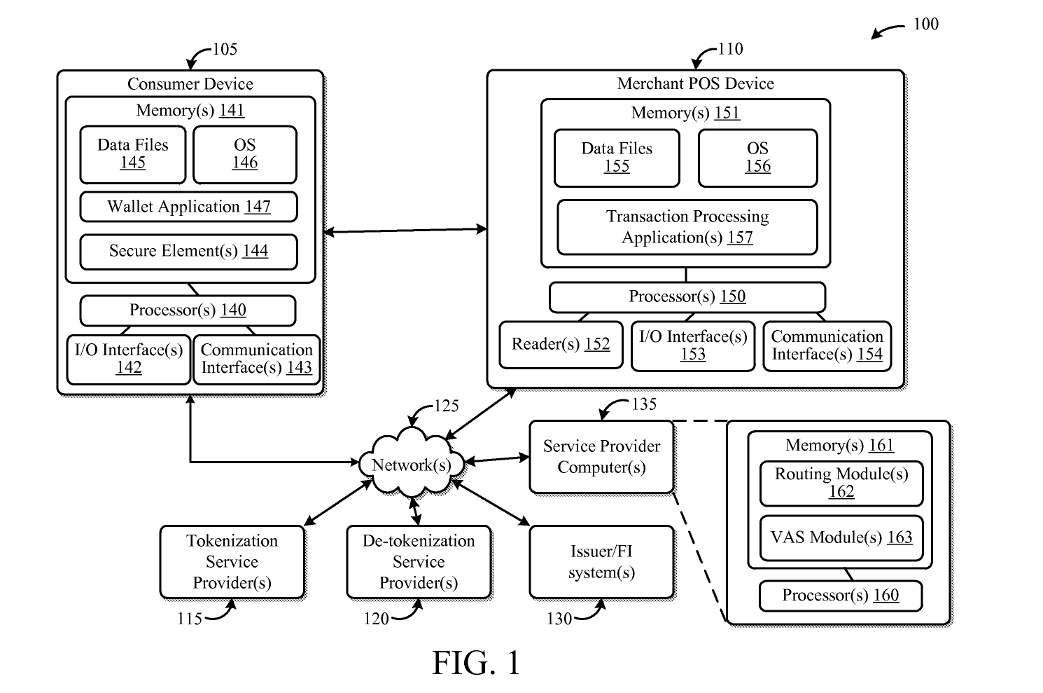

FIG. 1 represents a block diagram of an example system 100 that may be utilized in accordance with various embodiments of the disclosure to facilitate the distribution of tokenization and de-tokenization services. In certain embodiments, the system 100 may facilitate the receipt of a token from a tokenization service provider and the de-tokenization of the token from a separate de-tokenization service provider. Additionally, the system 100 may facilitate the intelligent routing of tokens to appropriate de-tokenization service providers. As shown in FIG. 1, the system 100 may include one or more consumer devices 105, one or more merchant POS devices 110 (e.g., merchant POS terminals, merchant registers, merchant computers, etc.), one or more tokenization service providers 115, and/or one or more de-tokenization service providers 120. One or more suitable networks 125 (e.g., local networks, cellular networks, the Internet, transaction networks, etc.) may facilitate communication between various components of the system. Additionally, although a merchant POS device 110 is illustrated as a recipient device for a payment transaction, other types of recipient devices may be utilized, such as a mobile device or a payee, etc. As desired, the system 100 may additionally include a wide variety of other entities associated with payment transactions, such as one or more issuer/financial institution systems 125, one or more issuer/financial institution systems 130, and/or one or more service provider computers 135 (e.g., service provider computers that route transactions including tokens, service provider computers that perform VAS functionality, etc.).

With reference to FIG. 1, any number of consumer devices 105 may be provided. Examples of suitable consumer devices 105 include, but are not limited to, mobile devices (e.g., mobile phones, smart phones, etc.) and/or other contactless transaction devices that support payment functionality. For example, a consumer device 105 may include an NFC chip, RF chip, or other communications component that facilitates the communication of transaction-related data to the merchant POS device 110 (or other recipient device) in association with a proposed payment transaction. In certain embodiments, a consumer device 105 may additionally be configured to obtain a token from a suitable tokenization service provider 115 and to communicate the token to the merchant POS device 110 in association with a payment transaction.

As desired, a consumer device 105 may include any number of processor-driven devices, including but not limited to, a mobile computer, an application-specific circuit, a minicomputer, a microcontroller, and/or any other processor-based device. A consumer device 105 may utilize one or more processors 140 to execute computer-readable instructions that facilitate the general operation of the consumer device 105 (e.g., call functionality, etc.) and/or the completion of a payment transaction. As a result of executing these computer-readable instructions, a special purpose computer or particular machine may be formed that facilitates the communication of transaction-related information and/or token information to a recipient device.

In addition to having one or more processors 140, the consumer device 105 may further include and/or be associated with one or more memory devices 141 (generally referred to as memory 141), input/output (“I/O”) interface(s) 142, and/or communication and/or network interface(s) 143. The memory 141 may be any computer-readable medium, coupled to the processor(s) 140, such as random access memory (“RAM”), read-only memory (“ROM”), and/or removable storage devices. The memory 141 may store a wide variety of data files 145 and/or various program modules, such as an operating system (“OS”) 146 and/or one or more wallet applications 147. In certain embodiments, a consumer device 105 may include one or more secure elements 144 configured to securely store and/or access information, such as payment applications, payment account information, and/or other transaction-related information. For example, one or more secure elements 144 may be configured to store payment data or payment information, such as information that may be utilized to generate tokens to be communicated to a recipient device. In other embodiments, one or more tokenization service providers 115 may facilitate the generation of tokens. A secure element 144 may be stored in the memory 141 and/or included as a separate component of the consumer device 105. For example, a secure element 144 may be a separate chip that is configured to communicate with primary computing functionality for the consumer device 105, such as a primary chip that includes NFC communications functionality. As desired, one or more transaction applications may be stored on a secure element 144. These transaction applications may be invoked by other components of the consumer device 105, such as the wallet application 147.

The data files 145 may include any suitable data that facilitates the operation of the consumer device 105 and/or interaction of the consumer device 105 with one or more other components of the system 100. For example, the data files 145 may include information associated with communicating with and/or invoking a tokenization service provider 115, information associated with accessing the secure elements 144 (if available), information associated with invoking a wallet application 147, information associated with outputting transaction-related information to a recipient device, etc. The OS 146 may be suitable module that facilitates the general operation of the consumer device 105, as well as the execution of other program modules. For example, the OS 146 may be, but is not limited to, a suitable mobile OS or a specially designed operating system. As desired, the consumer device 105 may additionally include one or more communication modules that facilitate interaction with other devices, such as merchant POS devices 110 equipped with contactless readers and/or other communications functionality (e.g., NFC functionality, RF functionality, Wi-Fi functionality, Bluetooth functionality, etc.). For example, a suitable near field communication module may be included in the consumer device 105.

The wallet application 147 may include one or more suitable software modules and/or applications configured to collect transaction-related information and/or to direct communication of transaction-related information to a recipient device. For example, the wallet application 147 may be configured to facilitate the collection of a token and/or other transaction-related information, as well as delivery of the token to a recipient device. As desired in certain embodiments, the wallet application 147 may invoke one or more tokenization service providers 115 in order to receive one or more tokens associated with payment credentials (e.g., an account number, etc.) and/or VAS data. For example, if the consumer device 105 does not include a secure element 144, then one or more external or remote tokenization service providers 115 may be invoked in order to receive tokens for use in payment transactions. In other embodiments, the wallet application 147 may invoke any number of suitable transaction applications, such as transaction applications stored on the secure elements 144, in order to receive one or more tokens. The transaction applications may be, for example, applications associated with various payment accounts and/or payment account issuers. In this regard, a secure element may act as a tokenization service provider.

According to an example embodiment, the wallet application 147 may be invoked in association with a proposed payment transaction. For example, a consumer may invoke the wallet application 147 in order to request completion of a transaction. As another example, a recipient device (or other system) may invoke or request the invocation of the wallet application 147 in association with a proposed payment transaction. Once invoked, the wallet application 147 may initiate a transaction in which transaction-related information (e.g., an obtained token, VAS information, etc.) will be communicated to a recipient device, such as the merchant POS device 110.

In certain embodiments, the wallet application 147 may obtain one or more tokens for communication to the merchant POS device 110. In certain embodiments, the tokens may include information representative of a payment credential (e.g., information associated with a payment account, track one and track two data associated with a payment device, etc.) and/or information associated with any number of VAS. Additionally, a wide variety of suitable methods and/or techniques may be utilized to generate tokens, such as key pair encryption, asymmetric key encryption, the generation of a transaction-specific value, and/or the generation of a credential and/or representative value associated with stored payment account and/or VAS information. In certain embodiments, tokens may also have a relatively limited lifespan and/or be associated with any number of other security techniques (e.g., hashing, check sums, etc.).

According to an aspect of the disclosure, the wallet application 147 may obtain the tokens from any number of tokenization service providers 115. For example, the wallet application 147 may communicate identification information for the consumer, consumer device 105, and/or a desired payment account or method of payment (e.g., an account identifier, etc.) to a tokenization service provider 115 along with a request for tokenization information. In response to the request, the tokenization service provider 115 may generate one or more tokens that are returned to the consumer device 105. In other embodiments, the wallet application 147 may request and receive token information from a secure element 144 and/or an associated transaction application stored by the secure element.

Once one or more tokens have been received, the wallet application 147 may direct communication of the tokens to the mobile POS device 110 (or other recipient device) in association with a proposed payment transaction. For example, the wallet application 147 may direct a suitable NFC communications interface to communicate the token information to the mobile POS device 110. As another example, the tokens may be read from the consumer device 105 by a suitable reader component associated with a recipient device. In certain embodiments, a peer to peer mode, such as the peer to peer mode of the International Standards Organization (“ISO”) 18092 standard, may be utilized to communicate tokens to a recipient device. As a result of utilizing a peer to peer mode, tokenized transaction-related information may be utilized to facilitate a transaction even if access to a secure element and/or use of a card emulation or reader/writer mode is restricted or limited.

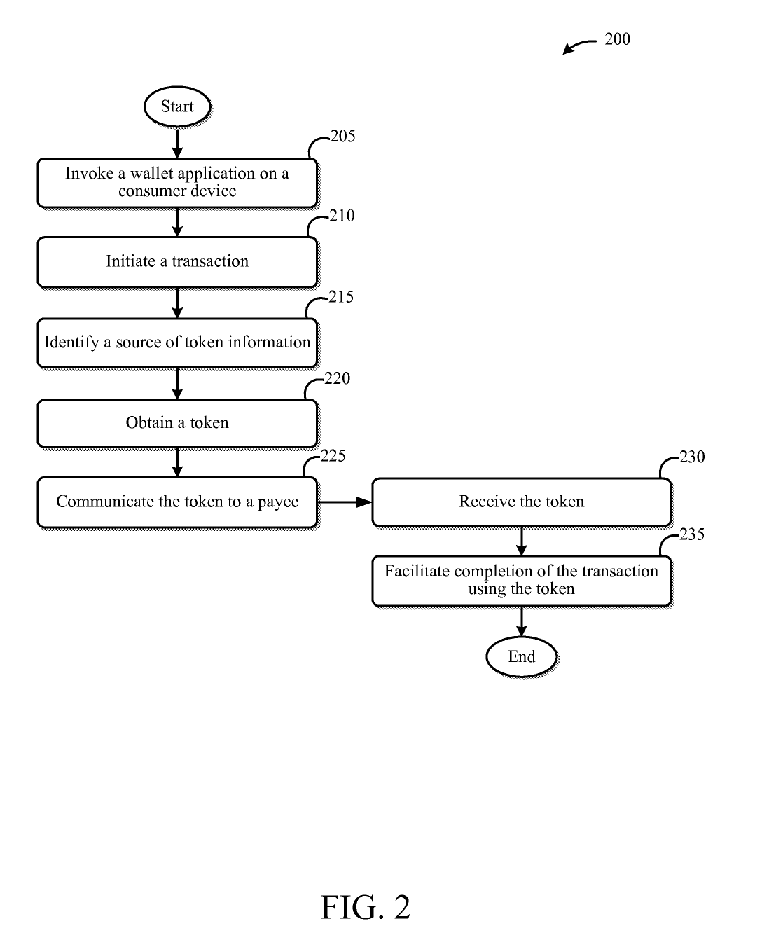

As desired in various embodiments, a wide variety of other information may be communicated to the merchant POS device 110 in addition to the token information. Examples of other types of information include, but are not limited to, consumer identification information, consumer device identification information, and/or certain types of VAS information. Once the information is communicated to the merchant POS device 110, the merchant POS device 110 may utilize at least a portion of the information to facilitate completion of a payment transaction. A few examples of the operations that may be performed by the wallet application 147 and/or the consumer device 105 are described in greater detail below with reference to FIG. 2. Additionally, although the consumer device 105 is described as requesting or obtaining token information for a payment transaction, in certain embodiments, a merchant POS device 110 (or other recipient device) may request one or more tokens. For example, a merchant POS device 110 may utilize information obtained from a consumer device 105 (e.g., an identity of the consumer, an identity of the consumer device 105, etc.) and/or received security data (e.g., a personal identification number (“PIN”) received from the consumer device 105 or a payment terminal, etc.) to request one or more tokens from a tokenization service provider 115.

The one or more I/O interfaces 142 may facilitate communication between the consumer device 105 and one or more input/output devices; for example, one or more user interface devices, such as a display, a keypad, a touch screen display, a microphone, a speaker, etc., that facilitate user interaction with the consumer device 105. The one or more network and/or communication interfaces 143 may facilitate connection of the consumer device 105 to one or more suitable networks, for example, the network(s) 125 illustrated in FIG. 1. In this regard, the consumer device 105 may receive and/or communicate information to other components of the system 100. For example, the consumer device 105 may communicate with one or more tokenization service providers 115 in order to obtain token information.

With continued reference to FIG. 1, any number of merchant POS devices 110 may be provided. A merchant POS device 110 may be a suitable device that facilitates the completion of payment transactions. In operation, the merchant POS device 110 may utilize one or more processors 150 to execute computer-readable instructions that facilitate the collection of transaction-related information (e.g., token information, information associated with items to be purchased, transaction amounts, etc.) and/or the generation and/or output of transaction-related requests (e.g., transaction authorization requests, value added service (“VAS”) requests, etc.). As a result of executing these computer-readable instructions, a special purpose computer or particular machine may be formed that facilitates the completion of POS payment transactions.

In addition to having one or more processors 150, the merchant POS device 110 may further include and/or be associated with one or more memory devices 151 (generally referred to as memory 151), one or more readers 152 or reader devices, input/output (“I/O”) interface(s) 153, and/or network interface(s) 154. The memory 151 may be any computer-readable medium, coupled to the processor(s) 150, such as random access memory (“RAM”), read-only memory (“ROM”), and/or a removable storage device. The memory 151 may store a wide variety of data files 155 and/or various program modules, such as an operating system (“OS”) 156 and/or one or more transaction processing applications or modules 157. The data files 155 may include any suitable data that facilitates the operation of the merchant POS device 110 and/or interaction of the merchant POS device 110 with one or more other components (e.g., one or more issuer systems 125, one or more service provider computers 135, etc.) of the system 100. For example, the data files 155 may include information associated with the readers 152, information that facilitates the request of token information, information that facilitates the processing of received token and/or other transaction-related information, acquiring platform information, service provider information, information associated with the generation of proposed transaction and/or VAS requests, information associated with available VAS, and/or routing information for proposed transactions.

The OS 156 may be a suitable module that facilitates the general operation of the merchant POS device 110, as well as the execution of other program modules. For example, the OS 156 may be, but is not limited to, Microsoft Windows®, Apple OSX™, Unix, a mainframe computer operating system (e.g., IBM z/OS, MVS, OS/390, etc.), or a specially designed operating system. The transaction processing applications or modules 157 may include any number of suitable software modules and/or applications that facilitate the receipt of transaction information (e.g., token information, information received from a consumer device 105, a purchase amount, information associated with purchased products, etc.), the generation of a proposed transaction, and/or the output of the proposed transaction. In certain embodiments, the transaction processing applications 157 may additionally facilitate the identification of information associated with a wide variety of value added services and the generation of one or more requests to invoke value added services, such as requests communicated to one or more service provider computers 135.

In certain embodiments, the transaction processing application 157 may be configured to receive information from the one or more readers 152 and process the received information in association with a payment transaction. For example, the transaction processing application 157 may receive token information and/or other transaction-related information collected from a consumer device 105. The transaction processing application 157 may then process the received information in order to complete a payment transaction and/or to facilitate any number of VAS associated with the payment transaction. For example, the transaction processing application 157 may communicate token information to a suitable de-tokenization service provider 120, which may be an issuer system 125 or a service provider computer 135. In certain embodiments, the transaction processing application 157 may identify the de-tokenization service provider 120 based upon information included in or associated with the token information. In other embodiments, the transaction processing application 157 may communicate a token along with a de-tokenization request or other transaction request (e.g., a transaction approval request, etc.) to a suitable service provider or other entity that routes the token to an appropriate de-tokenization service provider 120 for de-tokenization.

The de-tokenization service provider 120 may process received token information in order to determine an associated payment credential and/or other transaction-related information. A wide variety of suitable techniques may be utilized as desired to de-tokenize the tokenized information. For example, key information and/or a wide variety of decryption techniques may be utilized to decrypt tokenized information. As another example, the token information may be utilized to access stored transaction-related information (e.g., payment account information, etc.). In certain embodiments (e.g., embodiments in which an issuer facilitates de-tokenization), the de-tokenization service provider 120 may utilize at least a portion of the received information to approve and/or complete a funds transfer in association with a requested payment transaction. In other embodiments, the de-tokenization service provider 120 may return de-tokenized information (e.g., payment account information, VAS information, etc.) to the merchant POS device 110, a suitable service provider computer 135, or an issuer/financial system 130 for use in completing a payment transaction.

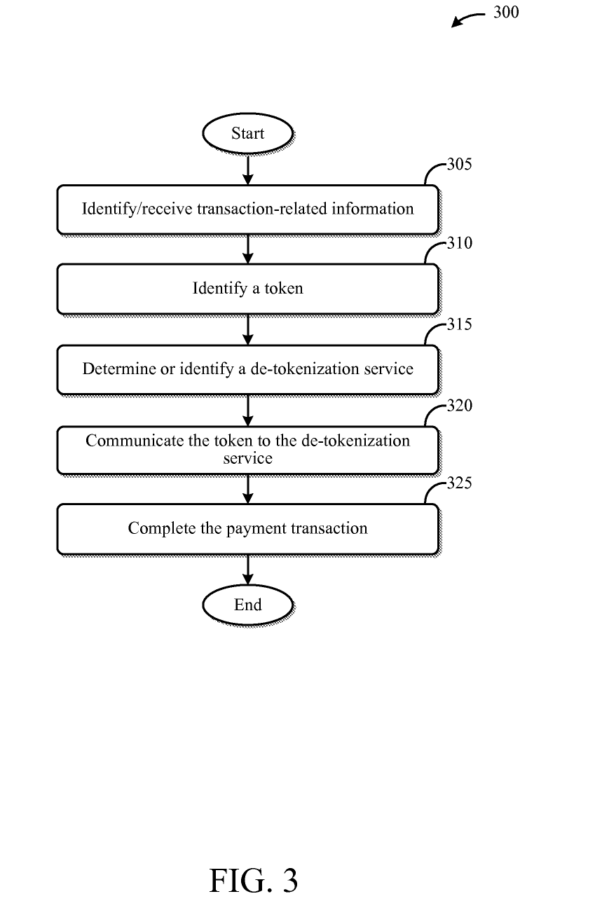

In certain embodiments, the transaction processing application 157 may utilize at least a portion of the transaction-related information and/or any received de-tokenization information to provide any number of transaction-related services. For example, the transaction processing application 157 may invoke and/or request (e.g., request a service provider computer, etc.) the invocation of a wide variety of VAS associated with a transaction, such as the application of coupons, the award and/or redemption of loyalty rewards, etc. The transaction processing application 157 may also generate a proposed transaction request that is output for routing and/or delivery to a suitable transaction processor, such as a payment account issuer system 130. In the event that the transaction is authorized, the transaction processing application 157 may invoke and/or request the invocation of a wide variety of VAS following the transaction, such as receipt generation and/or delivery services, product registration services, etc. Indeed, a wide variety of suitable operations may be performed by the transaction processing application 157. A few examples of the operations that may be performed by a transaction processing application 157 and/or the merchant POS device 110 are described in greater detail below with reference to FIGS. 2 and 3.

With continued reference to the merchant POS device 110, any number of suitable reader devices 152 may be provided. For example, an NFC contactless reader, an RF reader, or other suitable reader may be utilized. The one or more I/O interfaces 153 may facilitate communication between the merchant POS device 110 and one or more input/output devices; for example, one or more user interface devices, such as a display, a keypad, a mouse, a pointing device, a control panel, a touch screen display, a remote control, a microphone, a speaker, the reader devices 152, etc., that facilitate user interaction with the merchant POS device 110. The one or more network and/or communication interfaces 154 may facilitate connection of the merchant POS device 110 to one or more suitable networks and/or communication links. In this regard, the merchant POS device 110 may receive and/or communicate information to other components of the system 100, such as the issuer systems 125, the service provider computers 135, and/or other devices and/or systems.

With continued reference to FIG. 1, any number of tokenization service providers 115 may be included in the system 100. A tokenization service provider 115 may facilitate the generation of token information (e.g., a token representative of a payment credential, a tokenized payment credential, a unique transaction value, etc.) for use in a payment transaction. For example, a tokenization service provider 115 may receive a tokenization request from a consumer device 105 (or other component of the system 100) via any number of suitable networks 125, such as a cellular network, the Internet, or a transaction network. The tokenization service provider 115 may then process the received request in order to generate or otherwise prepare token information that is returned to the consumer device 105. In certain embodiments, the tokenization service provider 115 may utilized stored payment credential data and/or various token data, such as stored keys, certificates, and/or various unpredictable, nonce, or varying data to generate or create a token for a payment transaction. For example, the tokenization service provider 115 may access payment account information associated with a consumer or payer, and the tokenization service provider 115 may encrypt or encode the payment account information. As another example, the tokenization service provider 115 may identify or determine a representative value of payment account information. A wide variety of other methods and/or techniques may be utilized to generated tokenized information. In certain embodiments, a tokenization service provider 115 may include similar components as those discussed above for the merchant POS device 110. For example, a tokenization service provider 115 may include any number of processors, memories, I/O interfaces, and/or network/communication interfaces.

In certain embodiments, a generated token may include information that specifies or identifies a de-tokenization service provider 120 to which the token should be routed for de-tokenization. According to an aspect of the disclosure, the de-tokenization service provider 120 may be separate from the tokenization service provider 115. Additionally, a wide variety of different types of information may be utilized to identify a de-tokenization service provider 120. For example, the generated token may include a Banking Identification Number (“BIN”) that identifies a de-tokenization service provider 120 or that may be utilized to identify a de-tokenization service provider. As another example, the generated token may include a header, portion of a header, or other identifier that may be evaluated in order to determine a de-tokenization service provider.

With continued reference to FIG. 1, any number of de-tokenization service providers 120 may be included in the system 100. A de-tokenization service provider 120 may facilitate the processing of token information in order to determine underlying data, such as an underlying payment credential, and/or underlying VAS information for use in a payment transaction. Once a de-tokenization request is received, a de-tokenization service provider 120 may utilize key information, certificates, and/or various decryption algorithms and/or techniques in order to determine payment credential information (e.g., an account number, etc.) and/or other underlying information associated with the payment transaction. In certain embodiments, the de-tokenization service provider 120 may utilize information received from a card issuer in order to de-tokenize a token. Determined payment credential information may then be provided to an entity that requested de-tokenization and/or to a card issuer to facilitate approval of and/or settlement of the payment transaction. In certain embodiments, a de-tokenization service provider 120 may include similar components as those discussed above for the merchant POS device 110. For example, a de-tokenization service provider 120 may include any number of processors, memories, I/O interfaces, and/or network/communication interfaces.

Additionally, any number of issuer and/or financial institution systems 130 may be provided. An issuer system 130 may facilitate the backend processing of a proposed transaction. For example, an issuer system 130 may facilitate the approval and/or settlement of a proposed transaction. In certain embodiments, a proposed transaction may be routed to an issuer system 130 via a suitable transaction network (e.g., a debit network, a credit network, etc.), and the issuer system 130 may evaluate the proposed transaction. An approval or rejection of the proposed transaction may then be output for communication to a merchant POS device 110. The issuer system 130 may then facilitate the settlement of the proposed transaction. Additionally, as desired, the issuer system 130 may facilitate the de-tokenization of token information and/or the routing of token information to an appropriate de-tokenization service provider 120. In certain embodiments, an issuer system 130 may include similar components as those discussed above for the merchant POS device 110. For example, an issuer system 130 may include any number of processors, memories, I/O interfaces, and/or network/communication interfaces.

Additionally, any number of service provider computers 135 may be utilized as desired in various embodiments of the disclosure. A service provider computer may provide a wide variety of transaction-related, de-tokenization, and/or value added services (“VAS”) in association with transactions, such as coupon redemption services, loyalty services, location-based services, electronic receipt services, product registration services, warranty services, coupon issuance services, the routing of a proposed transaction to an issuer for approval and/or settlement purposes, and/or the routing of de-tokenization requests to appropriate de-tokenization service providers 120. In certain embodiments, a service provider computer 135 may include similar components as those discussed above for the merchant POS device 110. For example, a service provider computer 135 may include any number of processors 160, memory devices 161 (referred to generally as memory 161), I/O interfaces, and/or network/communication interfaces. As illustrated in FIG. 1, the memory 161 may include any number of data files and/or various software modules or applications, such as one or more routing modules 162 and/or one or more VAS modules 160. The VAS modules 160 may facilitate the processing of VAS requests and/or the delivery of VAS information to other components of the system 100, such as the merchant POS device 110 and/or the consumer device 105.

The routing modules 162 may include one or more suitable software modules and/or applications configured to facilitate the routing of transaction requests and/or de-tokenization requests. For example, a routing module 162 may route transaction approval requests to various issuer systems 130. Additionally, a routing module 162 may route transaction approvals and/or denials to various merchant POS devices 110, other recipient devices, and/or to various consumer devices 105. In certain embodiments, the routing modules 162 may additionally identify a de-tokenization service provider 120 to which token information should be delivered, and the routing modules 162 may facilitate routing and/or other communication of token information to the de-tokenization service provider 120. Although the routing modules 162 are described as being included in a service provider computer 135, other components of the system 100 may include similar routing modules.

A wide variety of suitable methods or techniques may be utilized to identify a de-tokenization service provider 120 to which one or more tokens will be routed. For example, in certain embodiments, a BIN or header included in the token may be evaluated in order to identify the de-tokenization service provider. In other embodiments, payment account issuer (e.g., card issuer, etc.) preferences (e.g., preferences associated with preferred de-tokenization services, load balancing preferences, preferences that are utilized to evaluate transaction-related information, etc.) may be evaluated in order to identify the de-tokenization service provider 120. In yet other embodiments, other transaction-related information (e.g., a transaction amount, an identity of the merchant, a geographical location of the merchant, an identity of the consumer, etc.) may be utilized in order to identify the de-tokenization service provider 120. Additionally, in certain embodiments, a BIN or other identifier may be associated with a plurality of de-tokenization service providers 120 (e.g., a plurality of de-tokenization servers, etc.), and one of the plurality of de-tokenization service providers may be selected based upon one or more other criteria (e.g., a routing module 162 may iterate or rotate between various de-tokenization service providers 120 to facilitate load balancing, loads for each of the de-tokenization service providers may be evaluated, etc.) may be evaluated in order to select a de-tokenization service provider.

A wide variety of suitable networks 125 and/or communication channels may be utilized in association with embodiments of the disclosure. Certain networks may facilitate communication between remote devices. For example, one or more telecommunication networks, cellular networks, wide area networks (e.g., the Internet) and/or transaction networks (e.g., branded networks (e.g., a VISA network, etc.), debit and/or PIN networks, and/or a wide variety of other suitable transaction networks) may facilitate communication between various components of the system 100. Other networks and connections, such as NFC connections, may facilitate communication between the consumer device 105 and the merchant POS device 110. Due to network connectivity, various methodologies as described herein may be practiced in the context of distributed computing environments. It will also be appreciated that the various networks may include a plurality of networks, each with devices such as gateways and routers for providing connectivity between or among networks. Additionally, instead of, or in addition to, a network, dedicated communication links may be used to connect various devices in accordance with an example embodiment.

The system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the disclosure should not be construed as being limited to any particular operating environment, system architecture, or device configuration.

### Operational Overview

FIG. 2 illustrates a flow diagram of an example process 200 for completing a payment transaction utilizing transaction-related information communicated from a payment device to a recipient device. In certain embodiments, the operations of the method 200 may be performed by a suitable consumer device and merchant POS device (or other recipient or payee device), such as the consumer device 105 and merchant POS device 110 illustrated in FIG. 1. The method 200 may begin at block 205.

At block 205, a wallet application (or other suitable transaction facilitating application), such as the wallet application 147 illustrated in FIG. 1, may be invoked on the consumer device 105. For example, the wallet application 147 may be invoked by a consumer (e.g., a user of the consumer device 105, etc.) or by another device (e.g., a merchant POS device 110 that initiates a peer to peer communications session, etc.). At block 210, the wallet application 147 may be utilized to initiate a transaction or, alternatively, a transaction request may be received from another device.

At block 215, a source of token information may be identified by the wallet application 147. In certain embodiments, a tokenization service provider, such as one of the tokenization service providers 115 illustrated in FIG. 1, may be identified as a source of token information. In other embodiments, a secure element may be identified as a source of token information. As desired, a wide variety of suitable parameters and/or criteria may be evaluated in order to identify a source of token information. For example, in the event that a secure element is not available, then a determination may be made to contact a tokenization service provider 115 for token information. Additionally, issuer preferences and/or payment account preferences (e.g., preferences associated with a type of payment account, etc.) may be evaluated in order to identify a tokenization service provider 115 to be contacted. In certain embodiments, a consumer device 105 may communicate a token request directed to a tokenization service provider 115. In other embodiments, a request may be routed through another entity, such as a service provider computer 135. In this regard, the service provider computer 135 may identify an appropriate tokenization service provider 115 to which the request will be routed. As a result, the service provider computer 135 may evaluate a wide variety of suitable routing parameters and/or preferences. Additionally, in certain embodiments, the service provider computer 135 may facilitate load balancing and/or distribution.

At block 220, one or more tokens may be obtained from a suitable source of token information. For example, the wallet application 147 may obtain a token from a tokenization service provider 115 or from another entity in communication with the tokenization service provider 115. In other embodiments, the wallet application 147 may obtain a token from a secure element. Once obtained, the one or more tokens may be communicated by the consumer device 110 to a suitable payee or recipient device, such as the merchant POS device 110. Additionally, although the consumer device 105 is described as obtaining a token, in other embodiments, a payee device may be configured to utilize transaction and/or consumer-related information to request and obtain a token.

At block 230, the merchant POS device 110 may receive one or more tokens from the consumer device 105. A wide variety of suitable information may be represented by and/or included in the token, such as payment account information, a representation of payment account information, and/or information associated with one or more VAS to be performed. At block 235, the merchant POS device 110 may facilitate completion of the payment transaction utilizing the received token. For example, the merchant POS device 110 may communicate any number of payment authorization requests, VAS requests, and/or de-tokenization requests to various card issuer systems, service provider systems, and/or de-tokenization service providers 120 in order to facilitate completion of the payment transaction. The method 200 may end following block 235.

As mentioned above, a wide variety of different types of information may be communicated by the consumer device 105 to the merchant POS device 110. This information may include payment-related data and/or a wide variety of VAS data, as well as representative values and/or links to various data. Payment-related data may include, for example, one or more tokens, identification information for a payment account to be utilized in association with a transaction (e.g., an identifier of an account issuer, etc.), consumer identification information that may be utilized to identify or select a payment account, consumer device identification information (e.g., device identifier, a mobile telephone number, etc.) that may be utilized to identify or select a payment account, and/or consumer authorization data (e.g., a PIN number, etc.). VAS data may include information associated with the provision of a wide variety of VAS in association with the transaction and, as desired, at least a portion of the VAS data may be tokenized. These VAS may be implemented by the merchant POS device 110 and/or by any number of suitable service provider computers directly or indirectly in communication with the merchant POS device 110. A wide variety of different types of VAS may be implemented as desired in various embodiments, and each of the VAS may be associated with information received from the consumer device 105 and/or accessed from a suitable data source on behalf of the consumer. Examples of suitable pre-transaction VAS include, but are not limited to, electronic wallet services, loyalty services, coupon redemption services, location-based mobile services. Examples of suitable post-transaction VAS include, but are not limited to, electronic receipt services, product registration services, product warranty services, coupon and/or offer issuance services, targeted advertisement services, receipt reconciliation with issuer statement services, etc. Various VAS may be invoked prior to the completion of a transaction, during the completion of the transaction, and/or following the completion of the transaction.

An example electronic wallet service, which may alternatively be implemented as a transaction processing service, may facilitate the identification of a payment account to utilize in association with a transaction, as well as the verification of a consumer's identity. A loyalty service may identify an applicable loyalty account of the consumer, such as a loyalty account with the merchant. The loyalty service may then facilitate the issuance and/or redemption of loyalty points and/or loyalty rewards in association with the transaction. A coupon redemption service may compare products being purchased (e.g., UPCs, etc.) with available coupons (e.g., coupons identified from received transaction information, coupons stored at the service provider in association with the consumer, coupons accessed from an external data source, etc.), and the coupon redemption service may identify coupons that may be redeemed. The coupon redemption service may then facilitate the communication of applied coupons to coupon issuers, and the distribution of redeemed coupon revenue to the merchant. A location-based mobile service may perform a wide variety of suitable services based upon received location information (e.g., GPS coordinates, etc.) for a consumer device. For example, a location-based mobile service may evaluate a consumer device location based upon consumer transaction processing preferences, and the location-based service may determine whether the transaction may be completed based at least in part upon the evaluation. For example, a consumer may specify that a consumer device (e.g., a mobile device of a child) can only be used at gas stations and/or grocery stores in order to complete transactions. A location-based service may utilize GPS coordinates for the consumer device to identify a merchant for a proposed transaction, and the location-based service may determine whether a transaction can be approved for the merchant. As another example of a location-based service, a consumer may request different VA services in different states and/or geographical regions. Indeed, a wide variety of different location-based services may be provided as desired.

An example electronic receipt service may generate electronic receipts for a transaction, and the electronic receipts may be delivered to any number of recipients, such as the merchant POS device 110 and/or the consumer device 105. An example product registration service may automatic complete a product registration application on behalf of the consumer and deliver the registration application to a suitable recipient, such as a manufacturer. As desired, a consumer may specify the types of products (e.g., electronics, appliances, etc.) for which product registration services will be provided. An example product warranty service may identify and store product warranty information on behalf of the consumer. Another example product warranty service may evaluate consumer preferences in order to automatically (or upon prompting) purchase an extended warranty for a purchased product. An example coupon issuance service may identify, based upon, for example, the purchased products and/or historical purchases, one or more coupons to be issued to the consumer (e.g., coupons that may be printed on the back of or otherwise associated with a receipt). Similarly, a targeted advertisement service may identify advertisements and/or promotions to be communicated to the consumer. An example receipt reconciliation service may compare a purchase amount to a subsequently obtained issuer statement (e.g., a credit card statement, a bank statement, etc.) and identify any discrepancies. In other words, an example reconciliation service may conduct an audit of the transaction on behalf of the consumer and/or the merchant.

FIG. 3 illustrates a flow diagram of an example process 300 for determining or identifying a de-tokenization service in association with the completion of a payment transaction. In certain embodiments, the operations of the method 300 may be performed by a suitable merchant POS device, a suitable card issuer, or a suitable service provider, such as the merchant POS device 110, the card issuer system 130, or the service provider computer 135 illustrated in FIG. 1. The method 300 may begin at block 305.

At block 305, transaction-related information may be identified and/or received. For example, transaction-related information may be received in association with a transaction approval request or a de-tokenization request. At block 310, one or more tokens included in the received information may be identified. For example, received information may be parsed in order to identify one or more tokens. As another example, a header associated with received information may be evaluated in order to identify one or more tokens.

At block 315, a suitable de-tokenization service or de-tokenization service provider 120 may be identified or determined. A wide variety of suitable information may be evaluated in order to determine a de-tokenization service provider, such as information included in one or more tokens (e.g., a BIN, a header, etc.), issuer preferences, merchant preferences, consumer preferences, geographical information, a transaction amount or other transaction-related information, etc. Additionally, a wide variety of suitable methods and/or techniques may be utilized to identify or determine a suitable de-tokenization service. For example, in certain embodiments, a BIN or header included in the token may be evaluated in order to identify the de-tokenization service provider. In other embodiments, payment account issuer (e.g., card issuer, etc.) preferences (e.g., preferences associated with preferred de-tokenization services, load balancing preferences, preferences that are utilized to evaluate transaction-related information, etc.) may be evaluated in order to identify the de-tokenization service provider 120. In yet other embodiments, other transaction-related information (e.g., a transaction amount, an identity of the merchant, a geographical location of the merchant, an identity of the consumer, etc.) may be utilized in order to identify the de-tokenization service provider 120. Additionally, in certain embodiments, a BIN or other identifier may be associated with a plurality of de-tokenization service providers 120 (e.g., a plurality of de-tokenization servers, etc.), and one of the plurality of de-tokenization service providers may be selected based upon one or more other criteria (e.g., a routing module 162 may iterate or rotate between various de-tokenization service providers 120 to facilitate load balancing, loads for each of the de-tokenization service providers may be evaluated, etc.) may be evaluated in order to select a de-tokenization service provider.

At block 320, the one or more tokens may be routed or otherwise communicated to the identified or determined de-tokenization service. In this regard, underlying payment credentials and/or other information (e.g., VAS information, etc.) may be determined and/or obtained. The payment transaction may then be approved, settled, and/or otherwise completed at block 325. Operations of the method may then end following block 325.

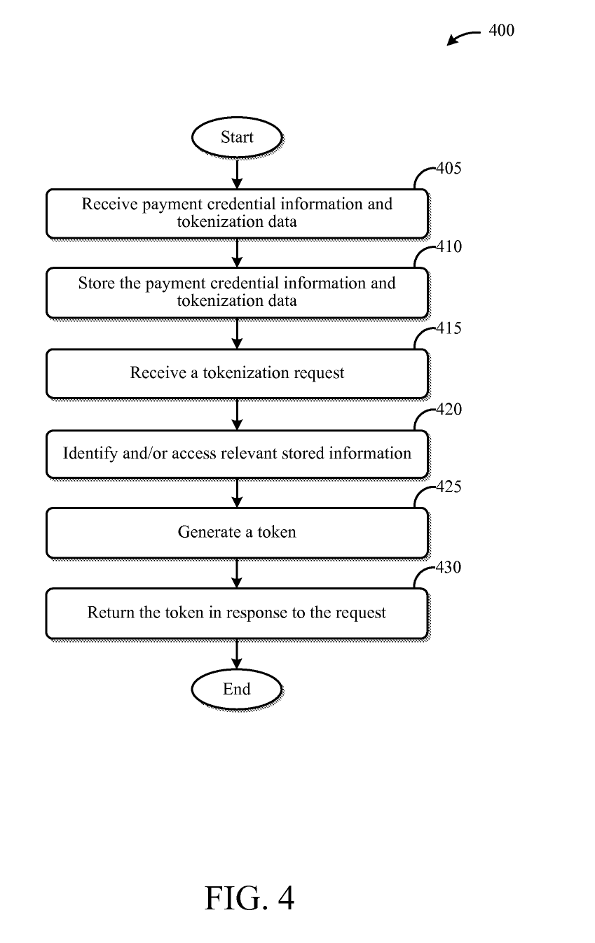

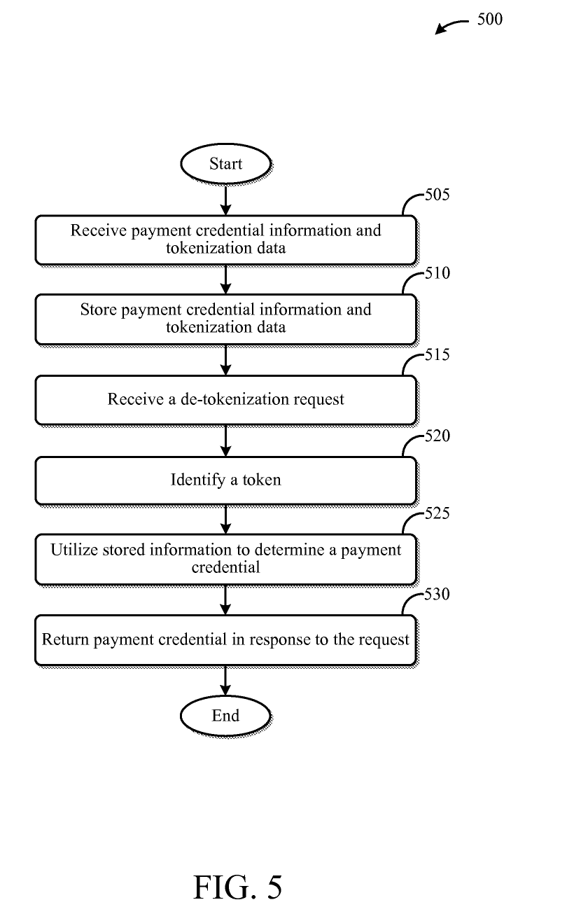

FIGS. 4 and 5 illustrate flow diagrams of example processes for tokenizing and de-tokenizing payment credentials, in accordance with illustrative embodiments of the disclosure. According to an aspect of the disclosure, tokenization and de-tokenization services may be distributed. Such distribution may decrease transaction-related delays as a single entity is not required to perform both tokenization and de-tokenization.

Turning first to FIG. 4, an example process 400 for generating one or more tokens is illustrated. In certain embodiments, the process 400 may be performed by a suitable tokenization service provider, such as one of the tokenization service providers 115 illustrated in FIG. 1. The process 400 may begin at block 405.

At block 405, payment credential information (e.g., payment account information, VAS information, etc.) and/or tokenization data (e.g., encryption data, keys, algorithms for generating tokens, etc.) may be received, for example, from one or more suitable card issuers and/or financial institution systems. At least a portion of the received information may then be stored at block 410. In this regard, the received information may be accessed in order to generate tokens associated with payment transactions.

At block 415, a tokenization request or a request for one or more tokens may be received. Information included in the request, such as an identifier of a consumer or an identifier of a consumer device 105, may then be utilized to identify and/or access relevant information associated with payment credentials for the consumer. At block 425, one or more new tokens may be generated for a proposed payment transaction. A wide variety of suitable methods, techniques, and/or algorithms may be utilized to generate a token. For example, static payment credential may be processed utilizing one or more keys, certificates, and/or unpredictable or varying nonce data in order to generate a token for use in conjunction with a proposed payment transaction. Once generated, at block 430, the one or more tokens may be returned to a requesting device (e.g., a consumer device 105, etc.) in response to the received tokenization request. The method 400 may then end following block 430.

FIG. 5 illustrates an example process 500 for decrypting and/or otherwise de-tokenization one or more tokens. In certain embodiments, the process 500 may be performed by a suitable de-tokenization service provider, such as one of the de-tokenization service providers 120 illustrated in FIG. 1. The process 500 may begin at block 505.

At block 505, payment credential information (e.g., payment account information, VAS information, etc.) and/or tokenization data (e.g., encryption data, keys, algorithms for generating tokens, etc.) may be received, for example, from one or more suitable card issuers and/or financial institution systems. At least a portion of the received information may then be stored at block 510. In this regard, the received information may be accessed in order to provide de-tokenization services in association with payment transactions. In certain embodiments, the information received by the de-tokenization service provider 120 may be similar to information received by a tokenization service provider 115. In this regard, the tokenization service provider 115 and de-tokenization service provider 120 may independently generate tokens and/or decrypt or de-tokenize tokens in order to identify relevant underlying information.

At block 515, a de-tokenization request may be received along with one or more tokens. At block 520, one or more tokens and/or other information included in the request, such as an identifier of a consumer, an identifier of a consumer device 105, an identifier of a card issuer, a token header, etc., may be identified. At least a portion of the identified information may then be utilized to identify and/or access relevant information associated with de-tokenizing the one or more tokens. At block 525, at least a portion of the stored information may be utilized to decrypt or de-tokenize the one more tokens in order to determine relevant information for the payment transaction, such as a payment credential and/or various VAS information. One or more new tokens may be generated for a proposed payment transaction. Once determined, at block 530, the payment credential (e.g., payment account number, etc.) and/or other information may be returned to a requesting device (e.g., a consumer device 105, etc.), provided to an issuer system, and/or utilized to complete a payment transaction. The method 500 may then end following block 530.

The operations described and shown in the methods 200, 300, 400, and 500 of FIGS. 2-5 may be carried out or performed in any suitable order as desired in various embodiments of the disclosure. Additionally, in certain embodiments, at least a portion of the operations may be carried out in parallel. Furthermore, in certain embodiments, less than or more than the operations described in FIGS. 2-5 may be performed.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

Various block and/or flow diagrams of systems, methods, apparatus, and/or computer program products according to example embodiments of the disclosure are described above. It will be understood that one or more blocks of the block diagrams and flow diagrams, and combinations of blocks in the block diagrams and flow diagrams, respectively, can be implemented by computer-executable program instructions Likewise, some blocks of the block diagrams and flow diagrams may not necessarily need to be performed in the order presented, or may not necessarily need to be performed at all, according to some embodiments of the disclosure.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A computer-implemented method, comprising:
receiving, by a payment transaction service provider system comprising one or more computers, information associated with a proposed payment transaction, wherein the information comprises at least a token generated by a tokenization service provider;
identifying, by the payment transaction service provider system, a de-tokenization service provider separate from the tokenization service provider based at least in part upon the received information; and
routing, by the payment transaction service provider system to the de-tokenization service provider, at least the token for processing.

2. The computer-implemented method of claim 1, wherein receiving information associated with the proposed payment transaction further comprises receiving information from one of (i) a merchant device, (ii) a consumer device, or (iii) a merchant acquiring system.

3. The computer-implemented method of claim 1, wherein the token is associated with at least one of (i) a payment credential, (ii) payment account information, or (iii) information associated with at least one value added service.

4. The computer-implemented method of claim 1, wherein identifying the de-tokenization service provider further comprises:
identifying, by the payment transaction service provider system, a banking identification number included in the token; and
determining, by the payment transaction service provider system, the de-tokenization service provider based at least in part upon the banking identification number.

5. The computer-implemented method of claim 4, wherein the banking identification number is associated with a plurality of de-tokenization service providers and further comprises:
selecting, by the payment transaction service provider system, one of the plurality of de-tokenization service providers based at least in part on one or more criteria.

6. One or more computer-readable media configured to store computer-executable instructions that, responsive to execution by one or more processors, cause operations to be performed comprising:
receiving information associated with a proposed payment transaction, wherein the information comprises at least a token generated by a tokenization service provider;
identifying a de-tokenization service provider separate from the tokenization service provider based at least in part upon the received information; and
routing to the de-tokenization service provider at least the token for processing.

7. The one or more computer-readable media of claim 6, wherein receiving information associated with the proposed payment transaction further comprises receiving information from one of (i) a merchant device, (ii) a consumer device, or (iii) a merchant acquiring system.

8. The one or more computer-readable media of claim 6, wherein the token is associated with at least one of (i) a payment credential, (ii) payment account information, or (iii) information associated with at least one value added service.

9. The one or more computer-readable media of claim 6, wherein identifying the de-tokenization service provider further comprises:
identifying a banking identification number included in the token; and
determining the de-tokenization service provider based at least in part upon the banking identification number.

10. The one or more computer-readable media of claim 9, wherein the banking identification number is associated with a plurality of de-tokenization service providers and further comprises:
selecting one of the plurality of de-tokenization service providers based at least in part on one or more criteria.

11. A computer-implemented method, comprising:
receiving, from a requesting device by a tokenization service provider system comprising one or more computers, a request to generate a token for use in a payment transaction;
generating, by the tokenization service provider system in response to the received request, the token, the token comprising information that facilitates an identification of a de-tokenization service provider system separate from the tokenization service provider system; and
communicating, by the tokenization service provider system, the generated token to the requesting device.

12. The computer-implemented method of claim 11, wherein the token is associated with at least one of (i) a payment credential, (ii) payment account information, or (iii) information associated with at least one value added service.

13. The computer-implemented method of claim 11, wherein receiving the request further comprises receiving the request from one of (i) a consumer device or (ii) a merchant device.

14. The computer-implemented method of claim 11, wherein the information that facilitates the identification of the de-tokenization service provider further comprises a banking identification number.

15. The computer-implemented method of claim 14, wherein the banking identification number is associated with a plurality of de-tokenization service providers and further comprises:
selecting, by the tokenization service provider system, one of the plurality of de-tokenization service providers based at least in part on one or more criteria.

16. One or more computer-readable media configured to store computer-executable instructions that, responsive to execution by one or more processors, cause operations to be performed comprising:
receiving, from a requesting device, a request to generate a token for use in a payment transaction;
generating the token in response to the received request, wherein the token comprises information that facilitates an identification of a de-tokenization service provider system separate from the tokenization service provider system; and
communicating the generated token to the requesting device.

17. The one or more computer-readable media of claim 16, wherein the token is associated with at least one of (i) a payment credential, (ii) payment account information, or (iii) information associated with at least one value added service.

18. The one or more computer-readable media of claim 16, wherein receiving the request further comprises receiving the request from one of (i) a consumer device or (ii) a merchant device.

19. The one or more computer-readable media of claim 16, wherein the information that facilitates the identification of the de-tokenization service provider further comprises a banking identification number.

20. The one or more computer-readable media of claim 19, wherein the banking identification number is associated with a plurality of de-tokenization service providers and the operations further comprise:
selecting one of the plurality of de-tokenization service providers based at least in part on one or more criteria.
